(19) United States
(12) Patent Application Publication
(10) Pub. No.: US 2020/0341486 A1
(43) Pub. Date: Oct. 29, 2020

(54) METHOD AND APPARATUS FOR PERFORMING SIMULTANEOUS LOCALIZATION AND MAPPING

(71) Applicant: COMMISSARIAT A L'ENERGIE ATOMIQUE ET AUX ENERGIES ALTERNATIVES, Paris (FR)

(72) Inventors: Roxana DIA, Paris (FR); Suzanne LESECQ, Paris (FR); Nicolas MAREAU, Paris (FR); Julien MOTTIN, Paris (FR); Diego PUSCHINI PASCUAL, Paris (FR); Tiana RAKOTOVAO ANDRIAMAHEFA, Paris (FR)

(21) Appl. No.: 16/847,591

(22) Filed: Apr. 13, 2020

(30) Foreign Application Priority Data
Apr. 29, 2019 (EP) 19315027.3

(51) Int. Cl. G05D 1/02; G06N 7/00; G06T 7/579; G06T 7/73; G06K 9/00

(52) U.S. Cl. CPC G05D 1/0253; G05D 1/0238; G05D 1/0274; G06N 7/005; G06T 2207/30244; G06T 7/74; G06K 9/00805; G05D 2201/0207; G06T 7/579

(57) ABSTRACT

A method of performing simultaneous localization of a mobile body and mapping of its environment, includes the steps of: a) defining an occupancy grid (G) on a region of the environment and a pose grid (Π) comprising for the mobile body; b) receiving a first time series of distance measurements (z₁, z₂) and, upon reception of a distance measurement: either b1) updating occupancy probabilities of the occupancy grid; or b2) updating pose probabilities of the pose grid; and c) receiving a second time series of odometry measurements (u₁, u₂), each of the measurements being representative of a motion of the mobile body in the environment and, upon reception of an odometry measurement, updating the pose probabilities of the pose grid. An apparatus for carrying out such a method is also provided.

### CROSS-REFERENCE TO RELATED APPLICATIONS

This application claims priority to foreign European patent application No. EP 19315027.3, filed on Apr. 29, 2019, the disclosure of which is incorporated by reference in its entirety.

### FIELD OF THE INVENTION

The invention relates to a method of performing simultaneous localization of a mobile body and mapping of its environment using distance (or “range”) and motion sensors. It also relates to an apparatus for carrying out such a method.

The invention applies, in particular, to the field of the navigation of robots, drones, autonomous vehicles, etc. and more generally to that of perception.

### BACKGROUND

In the following, “mapping the environment” will designate the task of determining the position, in a suitable reference frame, of physical bodies within a region of space surrounding in whole or in part the mobile body (also called a “carrier”). “Localization” refers to the task of determining at least the position, and preferably also the heading, of the mobile body within such a region of space. “Performing simultaneous localization and mapping” refers to a situation wherein signals provided by sensors are processed to determine the position/heading of the mobile body (carrier) and simultaneously detect and localize obstacles in the surrounding space.

The moving body may be a robot, drone, autonomous vehicle or the like, or even a device which cannot move autonomously but is carried by a person or a machine (e.g. an “electronic white cane” assisting visually impaired people).

By “physical body” (also called an “obstacle”) it is meant any physical object or substance that exhibits individuality and can be detected by an appropriate sensor. Thus, inanimate objects, be they natural or artificial, plants, animals, human beings, but also liquid or solid particles in suspension in the air, such as clouds, or indeed liquid or gaseous masses, are considered to be physical bodies.

A distance (or “range”) sensor is a sensor which provides information about at least the distance to a nearest obstacle in its field of view. Its physical operating principle is irrelevant: sensors as diverse as LIDARs, radars, sonars, etc. may be used to implement the inventive method and apparatus. Some distance sensors may provide additional information, e.g. the distance of all obstacles in a field of view and in some cases the azimuth/elevation of said obstacles.

A distance sensor may be considered to be of the “narrow-angle” or of the “wide-angle” type. A distance sensor is considered to be “wide-angle” when there is a non-negligible likelihood that several different obstacles are simultaneously present inside its field of view, and at a same distance from it (taking into account the finite resolution of the distance measurement). Conversely, a distance sensor is considered to be “narrow-angle” when such likelihood is negligible. Therefore, these definitions are application-dependent. While in most cases a sensor having a field of view of 15° or more can be considered to be a “wide-angle” sensor this is not always the case, and conversely a narrower field of view may nevertheless be considered “wide” enough to benefit from the invention.

A motion sensor is a sensor which provides information about the movements (translation and/or rotation) of the moving body with respect to its environment. Its physical operating principle is irrelevant: sensors as diverse as rotary encoders, inertial sensors, Doppler radars or sonars etc. may be used to implement the inventive method and apparatus.

Environment mapping can be performed according to several different techniques, most of which belong to one of two main families: geometric procedures, which are aimed at identifying the geometry of the objects of the surrounding space, and occupancy grid based procedures, which are aimed at determining whether a certain location is occupied by an obstacle. The occupancy grid technique is disclosed e.g. by [1]

Localization, also called “position estimation”, can also be performed according to different techniques. In particular, the so-called “Markov localization” [2] approach aims at estimating the probability distribution in space of the carrier's position, and its evolution as the carrier moves and/or new signals are acquired by different sorts of sensors. It is important to note that it is not possible to use motion (or “odometric”) sensor alone to perform position estimation, as the growth of the estimation error over time would be unbounded.

In the simplest cases, Markov localization assumes that the environment is known and static, i.e. there is a known “map” of the environment on which the carrier has to be localized. Researchers, however, have also tackled the more complex problem of simultaneous localization and mapping (SLAM) wherein the environment is unknown and/or dynamic, and a map of it has to be built simultaneously with the estimation of the position of the carrier.

Document [3] discloses a SLAM algorithm called FastSLAM wherein sensors (e.g. laser sensors) are used for detecting “landmarks” of the environment. The measurements issued by the sensors are used for updating a carrier position using particle filters, while the landmarks themselves are localized using extended Kalman filters. The method supposes that a measurement can be unambiguously associated to a given landmark, which is a rather stringent hypothesis. Moreover, it is computationally heavy (it requires a high number of Kalman filters) and the error of the pose estimation may diverge in some cases.

Document [4] discloses a SLAM algorithm wherein the environment is represented using an occupancy grid. The heading of the carrier is supposed to be known and its position is determined using the “scan matching” method. A drawback of this method is that the carrier heading is simply supposed to be known, which is not usually the case in real-word applications. Moreover, the method does not account for the impact of the uncertainty of the carrier position on the updating of the occupancy grid.

Document [5] discloses a SLAM method combining odometry and sonar measurements. The environment is represented using an occupancy grid updated by a Kalman filter, while a particle filter is used for tracking the pose of the carrier. A drawback of this method is that it does not account for the impact of the uncertainty of the positions of the obstacle on the updating of the carrier position.

Document [6] discloses a SLAM method using an occupancy grid for representing the environment and a pose grid for representing the carrier position and orientation. This approach has an exponential computational complexity, which makes it difficult to apply to embarked systems, having a limited computing power. Moreover, it relies on restrictive hypotheses (an insufficiently general sensor model, a specific motion model).

U.S. Pat No. 8,340,852 discloses the application of SLAM using an inertial measurement unit (IMU) and range sensors to autonomous vehicles. SLAM is performed using an optimization algorithm, which does not allow taking into account the measurement incertitude.

US 2004/013295 discloses a method of performing SLAM using a pair of cameras for acquiring images of the environment, detecting obstacles and identifying landmarks, and odometric sensors.

US 2016/0062361 discloses a navigation method fora mobile robot, including a first step wherein the robot moves along a path following input commands from an operator and detecting obstacle, and a second step wherein the robot moves autonomously upgrading a map of the environment and estimating its own position.

### SUMMARY OF THE INVENTION

The invention aims at overcoming, in full or in part, at least some of the drawbacks of the prior art. More particularly it aims at providing a SLAM method having an acceptable computational complexity, general applicability (i.e. avoiding overly-restrictive hypothesis) and explicitly accounting for uncertainties on sensor measurements. Advantageously, such a method should be able to be carried out by an embarked processor with limited computing power.

According to the invention, an object of the invention allowing achieving these aims in full or in part is a method of performing simultaneous localization of a mobile body and mapping of its environment, the method comprising the following steps, carried out by a data processor:
a) defining:
   an occupancy grid on a region of said environment, the grid comprising a plurality of cells, an occupancy probability by an obstacle being associated to each cell of the occupancy grid, and
   a pose grid comprising a plurality of cells, each representing a position and orientation of the mobile body, a pose probability being associated to each cell of the pose grid;
b) receiving a first time series of distance measurements, each of said measurements being representative of a distance between a point of the mobile body and at least one nearest obstacle and, upon reception of a distance measurement: either
   b1) updating the occupancy probabilities of the occupancy grid as a function of present values of said occupancy probabilities, of the received distance measurement and of the pose probabilities of the pose grid; or
   b2) updating the pose probabilities of the pose grid as a function of present values of said pose probabilities, of the received distance measurement and of the occupancy probabilities of the occupancy grid; and
c) receiving a second time series of odometry measurements (u₁, u₂), each of said measurements being representative of a motion of the mobile body in the environment and, upon reception of an odometry measurement, updating the pose probabilities of the pose grid as a function of present values of said pose probabilities and of the received odometry measurement.

Another object of the invention is an apparatus for performing simultaneous localization of a mobile body and mapping of its environment, comprising:
at least one input port for receiving a plurality of signals representative of a first time series of distance measurements arising from one or more distance sensor and a second time series of odometry measurements arising from one or more motion sensor; and
a data processor configured to receive as input said signals and to use them to construct an updated occupancy grid and an updated pose grid by applying such a method.

Yet another object of the invention is a mobile robot carrying such an apparatus.

### BRIEF DESCRIPTION OF THE DRAWINGS

Additional features and advantages of the present invention will become apparent from the subsequent description, taken in conjunction with the accompanying drawings, wherein:

FIG. 1 illustrates the notion of “direct” model of a distance sensor;

FIG. 2 illustrates the notion of occupancy grid;

FIG. 3, illustrates the notion of “inverse” model of a distance sensor;

FIG. 4 is a plot representing the spatial discretization of an inverse model on an occupancy grid;

FIG. 5 is a schematic diagram of an apparatus according to an embodiment of the invention;

FIG. 6 illustrates the unfolding of a method according to an embodiment of the invention;

FIG. 7 illustrates in detail a step of the method of FIG. 6, wherein a distance measurement is used for updating an occupancy grid;

FIG. 8 is a flow-chart of a computation involved in the step of FIG. 7;

FIG. 9 illustrates how the inverse model of a narrow-angle distance sensor may be computed;

FIG. 10 illustrates in detail a step of the method of FIG. 6, wherein a distance measurement is used for updating a pose grid;

FIG. 11 is a flow-chart of the step of FIG. 10, when a narrow-angle range sensor such as a LIDAR is used for measuring distances; and

FIGS. 12A, 12B and 12C illustrate some calculations required to carry out the method step of FIGS. 10 and 11 when a wide-angle range sensor is used.

### DETAILED DESCRIPTION

A range (or distance) sensor may be represented by use of a probabilistic model, which accounts for its finite precision, resolution and for possible measurement errors.

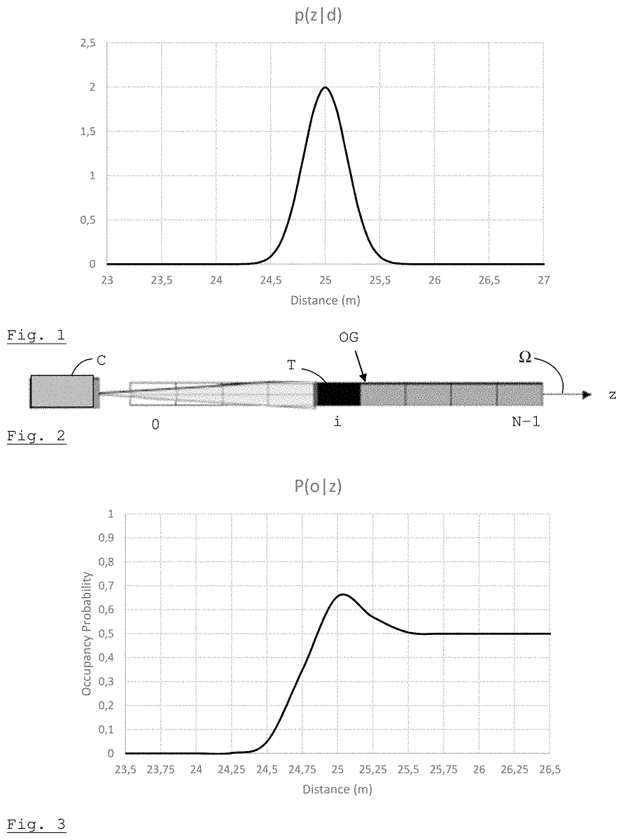

The idea is that a measurement output by the sensor does not necessarily indicate the exact distance between the sensor and the nearest obstacle in its field of view. Instead, for a given distance d, the output z of the sensor is a random variable characterized by a probability distribution p(z|d), constituting the “direct model” of the sensor. FIG. 1 presents an exemplary direct model of a sensor; a linear space 50 m long is considered and it is assumed that an obstacle is situated at d=25 m from the sensor. For a sensor with an error modeled by a Gaussian function, the most probable value taken by z will be 25 m (assuming that there are no systematic errors), but other values will be possible, with a probability density defined by the curve. In the case of an ideal sensor, one would have p(z|d)=δ(z−d), where δ is a Dirac Delta, and the measurement value z would always be equal to the true distance. The direct model of a sensor can be determined experimentally, or it can be obtained from data provided by the constructor (e.g., under a Gaussian hypothesis, the value of the standard deviation suffices to characterize the model).

Hereinafter, Ω will denote a spatial reference frame in one, two or three dimensions; an occupancy grid OG is a partition of a continuous and bounded region of a space generated by Ω into a number N of parts, called “cells” and designated by an index i∈[0, N−1]. The cell of index i is indicated by cᵢ. Without loss of generality, we shall consider a one-dimensional occupancy grid observed by a single distance sensor C (or a plurality of co-located sensors), the index i increasing with the distance from the sensor (c₀ therefore being the cell closest to the sensor and c_{N-1} the one furthest away). This configuration is illustrated on FIG. 2.

An obstacle T is a bounded continuous subset of Ω. A cell cᵢ is said to be occupied by an obstacle T if T∩cᵢ≠Ø, to be not occupied by T if A∩cᵢ=Ø. Stated otherwise, if the obstacle covers the cell even partially, the latter is considered to be occupied. Other conventions are possible, but in any event a cell must be either free (vacant), or occupied.

For each of the cells of the grid, we consider the binary random experiment “state” which can have one of the two outcomes {occupied; vacant} consisting in knowing whether or not the cell contains an obstacle or not. The state of the cell cᵢ is denoted sᵢ∈{eᵢ, oᵢ}. oᵢ will denote the realisation sᵢ=oᵢ (I;e. the cell is occupied), and eᵢ will denote the realisation sᵢ=eᵢ (i.e. the cell is empty).

An occupancy probability P(oᵢ)—or, equivalently, a vacancy probability P(eᵢ)=1−P(oᵢ)—is associated to each cell cᵢ of an occupancy grid (in the following, a capital “P” will denote a probability, and a lowercase “p” a probability density). Before any measurement, an a priori occupancy probability—often, but not necessarily equal to 0.5, is associated to each cell.

It is also considered that the position of the obstacles can only be known with the aid of uncertain distance sensors, characterized by a probabilistic model such as described above which may be written, in the single obstacle approximation, p(z|\vec{x}), \vec{x} being the position of the nearest obstacle (in several dimensions, it is a vector, expressed in cartesian, spherical, polar coordinates, etc. and not a simple scalar). The sensors may be telemetric lasers (also called LIDARs), sonars, infrared radars, time-of-flight cameras, etc. More generally, by taking into account the possibility of having k>1 obstacles in the field of view of the sensor, the inverse model may be written as p(z|\vec{x}₁, \vec{x}₂, . . . , \vec{x}ₖ), where \vec{x}ᵢ is the position of the i-th obstacle.

A measurement z arising from a sensor makes it possible to determine the conditioned probability of occupancy P(oᵢ|z) of a cell cᵢ. For a given measurement z, the set of probabilities P(oᵢ|z)∀i∈[0, N−1] constitutes what is called the “inverse model” of the sensor on the grid. Whilst the direct model of the sensor describes the response of the sensor as a function of the material world, the inverse model expresses the impact of the measurement on the occupancy grid, which is the model of the material world that is adopted, thereby justifying the term inverse model.

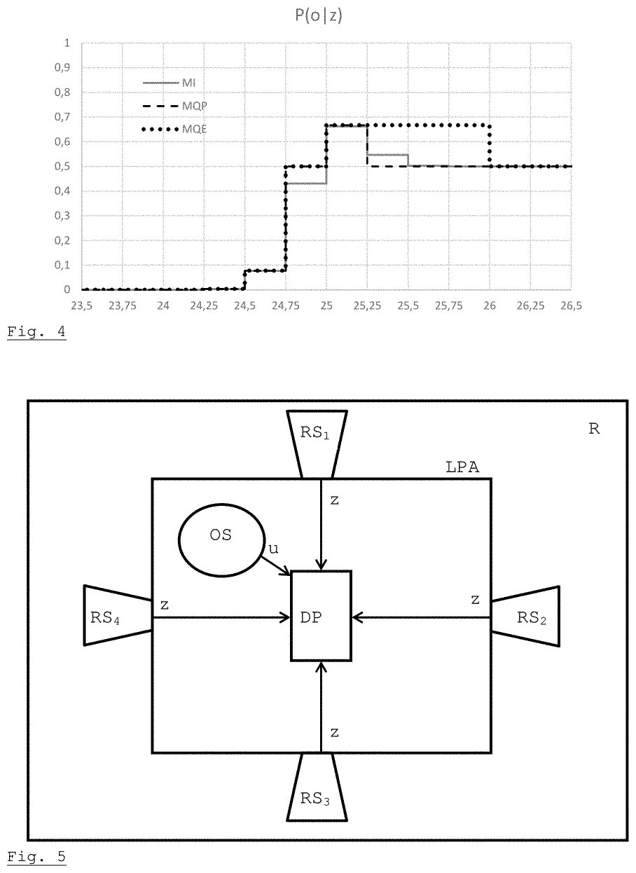

FIG. 3 presents a typical example of inverse model of a distance sensor, in a case where z=25 m. It may be verified that the occupancy probability is almost zero for the cells which are situated at a distance of less than 24.25 m from the sensor and attains a peak for a distance of 25 m (corresponding to the measurement provided by the sensor). Beyond 25 m, the occupancy probability decreases until it stabilizes at a value of 0.5, indicative of a total ignorance of the occupancy state of the cells which, being situated beyond the obstacle, are masked by the latter and therefore inaccessible to the sensor.

The inverse model, applied to range measurement, allows updating the occupancy probabilities of the occupancy grid.

Documents WO2017/050890 and EP 3 364 213 describe methods for updating the occupancy probabilities of an occupancy grid using a time series of range measurements from one or more “narrow-angle” distance sensors. European Patent Application 18305955 filed on Jul. 13, 2018 generalizes these methods to the case of “wide-angle” sensors. The teaching of these documents can be applied to the present invention

In accordance with the usage which prevails in the literature, FIG. 3 represents the inverse model by means of a smoothed curve. A more correct representation would be to display only the points corresponding to the limits of the cells of the grid: indeed, it is not possible to distinguish a “partially” occupied cell from another which would be “totally” occupied, in all cases the distance to the obstacle will be estimated as being the distance to the corresponding cell. This is the spatial error introduced by the grid.

Moreover, for reasons which are explained in WO2017/050890 and which will become apparent in the following, it is preferable to quantize the probability values by allowing them to only take values belonging to a finite set. Suitable quantizing schemes will be described later, see equations (13)-(28).

FIG. 4 shows the inverse model of FIG. 3 spatially discretized but not quantized (curve MI), spatially discretized and quantized taking, for each probability value of the continuous model, the smallest element of S₁ exceeding this probability value (curve MQE), spatially discretized and quantized taking, for each probability value of the continuous model, the closest element of S₁ (curve MQP).

Similarly, the pose of the carrier may be represented by a “pose grid” Π, comprising a plurality of cells, each associated to a pose probability. In a preferred embodiment of the invention, a “pose” is constituted by a position in two- or three-dimensions and a heading direction expressed by one or two angles. For some applications (e.g. a terrestrial robot such as an autonomous vehicle), the position will be defined in two dimensions and the heading direction will be expressed by an angle. The invention will be discussed with reference to this case, which is easier to represent on drawings, without loss of generality.

For instance, the position Xᵣ of the carrier may take its values in L={xᵢ, i=0 . . . M−1} and its heading αᵣ may take its values in A={αᵢ, i=0 . . . M′−1}. The pose xᵣ=(Xᵣ, αᵣ) will then take its values in Π=L×A, which is the pose grid. In the following, the pose grid Π will be represented by a two-dimensional grid; however, it should be understood that it often represents a parameter space of higher dimensions (e.g. three dimensions: a two-dimensional position and a one-dimensional heading) and that it may be represented, in a computer memory, by a one-dimensional, two-dimensional or higher-dimensional array.

As it will be discussed below, the pose grid is updated using both range measurement, provided by range sensors, and odometry measurement, provided by motion sensors. To this aim, a motion sensor may be represented by a “motion model” P(xᵣ*|xᵣ, u) which expresses the probability that the carrier takes a pose xᵣ* knowing that, at a previous time, it had a pose xᵣ and that an odometry measurement u has been received.

FIG. 5 is a very schematic representation of a localization and positioning apparatus LPA according to an embodiment of the invention, on a carrier R such as, e.g. a mobile robot or an autonomous vehicle. Apparatus LPA comprises a plurality of range (or distance) sensors RS₁, RS₂, RS₃, RS₄, of a same or of different types, each having a respective field of view and a motion or odometry sensor OS. In different embodiments, a single range sensor and/or several odometry sensors of a same or of different type may be used. Range measurements z and odometry measurements u are provided to a data processor DP (usually, a suitably-programmed microprocessor, microcontroller or digital signal processor, even if the use of a specific processing circuit based on programmable circuits such as FPGA and/or application-specific integrated circuits is also possible). Data processor DP includes a memory device storing data representing direct and inverse models of the range sensors and motion models for the motion sensors, and also storing executable code for carrying out a simultaneous localization and mapping method according to the invention, which will be described in detail hereafter.

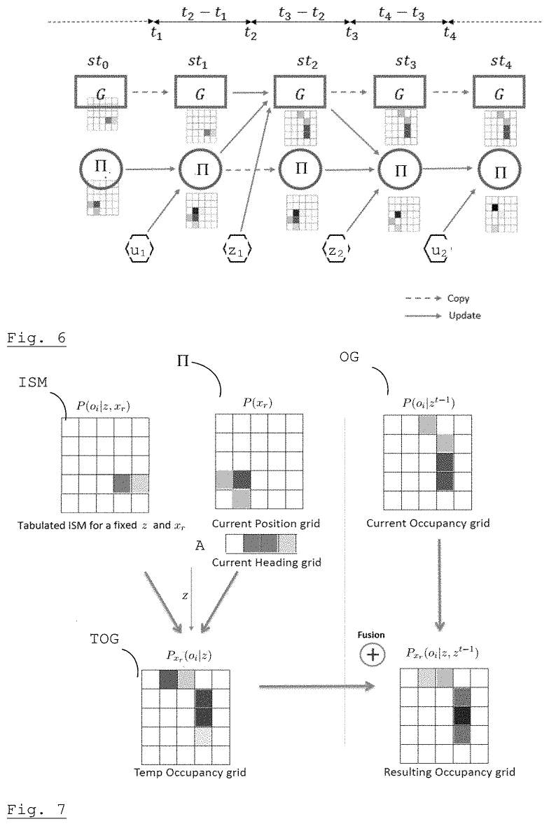

As illustrated on FIG. 6, according to the invention, odometry measurements u are used to update the pose grid Π without affecting the occupancy grid G while distance measurements may be used for updating either the pose grid (combined with the previous knowledge of the pose grid and occupancy grid) or the occupancy grid (combined with the previous knowledge of the occupancy grid and pose grid). For instance, in the example of FIG. 6:

Before time t₁ the occupancy grid G and the pose grid Π are in an initial state st₀. The state is characterized by an occupancy probability value for each cell of the occupancy grid, and a pose value for each cell of the pose grid.

At time t₁, a first odometry measurement u₁ is received, and used for updating the pose grid Π (more precisely, the pose probability of at least some of its cells) while the occupancy grid G remains unchanged. This corresponds to state st₁.

At time t₂, a first distance measurement z₁ is received. The measurement z₁ and the pose grid Π are used to compute an updated occupancy grid (more precisely: updated occupancy probabilities of at least some of its cells), while the pose grid remains unchanged (state st₂).

At time t₃, a second distance measurement z₂ is received. This time, this measurement is used—together with the occupancy grid G—to update the pose grid Π (more precisely, the pose probability of at least some of its cells). The occupancy grid remains unchanged (state st₃).

At time t₄, a second odometry measurement u₂ is received, which is used for updating the pose grid Π (i.e. its pose probabilities) while the occupancy grid G remains unchanged (state st₄).

It is important to note that the distance and odometry measurements may arrive asynchronously, and it is even possible that several measurements arrive simultaneously. However, two simultaneous odometry measurements must be processed sequentially, while two simultaneous distance measurements may be processed simultaneously, provided that one of them is used for updating the pose grid and the other one for updating the occupancy grid. Similarly, if an odometry measurement and a position measurement are received simultaneously, they may be processed simultaneously provided that the latter is used for updating the occupancy grid. It should be understood that two measurements are deemed to be “received simultaneously” when they are separated by a time interval smaller than a time resolution of the data processor, and that they are “processed simultaneously” is they are applied to a same state stᵢ of the occupancy and pose grids.

In the example of FIG. 6 two consecutive distance measurements are used, alternatively, for updating the occupancy grid and the pose grid. This is by no means essential. Different, possibly application-dependent, strategies may be used to determine which grid to update upon receiving a distance measurement.

It is apparent from FIG. 6 that the inventive method comprises three main steps (carried out several time, but not necessarily in a fixed order—see above):
updating the occupancy probabilities of the occupancy grid as a function of present values of said occupancy probabilities, of a received distance measurement and of the pose probabilities of the pose grid;
updating the pose probabilities of the pose grid as a function of present values of said pose probabilities, of a received distance measurement and of the occupancy probabilities of the occupancy grid; and
updating the pose probabilities of the pose grid as a function of present values of said pose probabilities and of a received odometry measurement.

In the following, possible embodiments of each one of these three steps will be described in detail.

The following notations will be used:
P(·) will represent the probability of an event;
p(·) will represent the probability density of a continuous random variable;
G is an occupancy grid composed of N>1 disjoint cells cᵢ, i=0, . . . N−1;
oᵢ is the event that cell cᵢ is occupied by an obstacle;
eᵢ is the event that cell cᵢ is empty (i.e. not occupied by an obstacle);
Π is a pose grid, which may be decomposed into a position grid L and a heading grid A. The position grid L is composed of M disjoint cells, corresponding to M discrete values xᵢ, i=0 . . . M−1 for the position Xᵣ of the carrier, while the heading grid A is composed of M′ disjoint cells, corresponding to M′ discrete values αⱼ j=0 . . . M′−1 for the heading αᵣ of the carrier.

xᵣ=(Xᵣ, αᵣ) represents a pose—i.e. a position and a heading. P(xᵣ) is the probabilty that the carrier takes pose xᵣ.

z is the result of a distance (or range) measurement, representing the distance between the carrier (more precisely, a point of the carrier) and an obstacle. In the following, it will be assumed that z can only take discrete values, which is required for digital processing.

u is the result of an odometry measurement, representing a movement (a translation, a rotation or a combination thereof) of the carrier. In the following, it will be assumed that u can only take discrete values, which is required for digital processing.

P(oᵢ|z, xᵣ) is the inverse model of a range sensor (ISM—inverse sensor model), associating an occupancy probability to each cell of the occupancy grid for a given range measurement result z and a pose of the carrier, xᵣ, deemed to be known. The ISM is supposed to be tabulated for all possible values of z and xᵣ.

P(xᵣ*|xᵣ, u) is the motion model, which expresses the probability that the carrier takes a pose xᵣ* knowing that, at a previous time, it had a pose xᵣ and that an odometry measurement u has been received. Again, this model is supposed to be tabulated for all possible values of u and xᵣ.

### Using a Range Measurement for Updating the Occupancy Grid

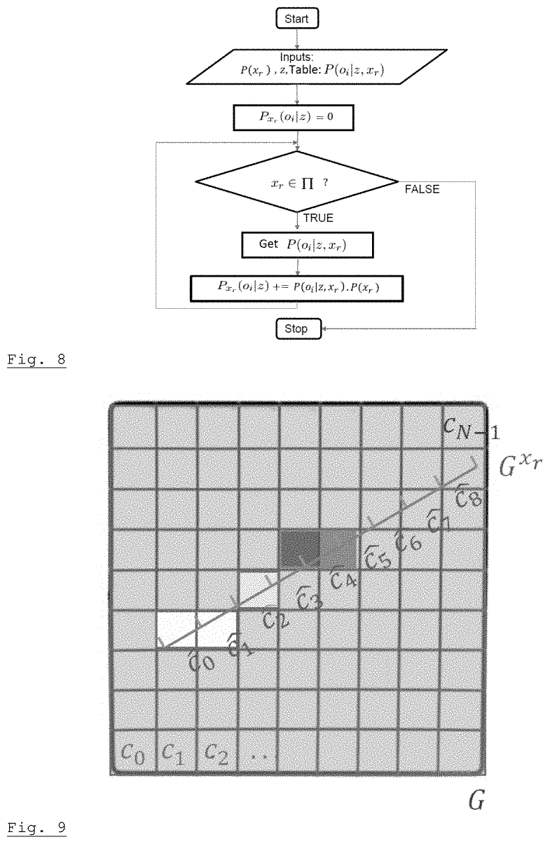

As illustrated on FIG. 7, the ISM P(oᵢ|z, xᵣ) is tabulated for all admissible values of z and xᵣ and stored in a memory device. The pose grid Π—and therefore the probability P(xᵣ) of all admissible poses—is also known. When a range measurement z is received, it allows computing the occupancy probabilities of a temporary occupancy grid Pₓᵣ(oᵢ|z)—reference TOG on FIG. 7—as follows:

$${P}_{xr} ( {o}_{i} \vert z ) = {\sum }_{{x}_{r} ∈ Π} P ( {o}_{i} \vert z , {x}_{r} ) P ( {x}_{r} \vert z ) = {\sum }_{{x}_{r} ∈ Π} P ( {o}_{i} \vert z , {x}_{r} ) P ( {x}_{r} ) \qquad ( 1 )$$

where the second equality accounts for the fact that the pose probability is independent from the range measurement. FIG. 8 is a flow-chart illustrating an iterative algorithm for calculating Pₓᵣ(oᵢ|z).

Then, the current occupancy probabilities—represented by P(oᵢ|z^{t-1})—is “fused” with the occupancy probabilities of the temporary grid Pₓᵣ(oᵢ|z) to obtain updated occupancy probabilities (i.e. an updated occupancy grid) P(oᵢ|z, z^{t-1}) as follows:

$${P}_{xr} ( {o}_{i} \vert z , {z}^{t - 1} ) = \frac{{P}_{xr} ( {o}_{i} \vert z ) P ( {o}_{i} \vert {z}^{t - 1} )}{{P}_{xr} ( {o}_{i} \vert z ) P ( {o}_{i} \vert {z}^{t - 1} ) + ( 1 - {P}_{xr} ( {o}_{i} \vert z ) ) ( 1 - P ( {o}_{i} \vert {z}^{t - 1} ) )} \qquad ( 2 )$$

See WO2017/050890 and EP 3 364 213.

FIG. 9 shows how P(oᵢ|z, xᵣ) is computed for the case of a range sensor having a narrow field of view. The ISM of the sensor for a given measurement value z may be represented by a segment decomposed in one-dimensional cells, each associated to a probability value. For instance, cells ĉ₀ and ĉ₁ may be associated to a probability value ε close to zero, meaning that it is almost impossible that—given measurement z—said cells are occupied. Cells ĉ₂, ĉ₃ and ĉ₄ have probability values equal to 0.3, 0.9, and 0.7, respectively. This means that cell ĉ₃ has the highest occupancy probability, cell ĉ₂ is likely to be empty and cell ĉ₄ is quite likely to be occupied. Cells ĉ₅-ĉ₈ have a probability value of 0.5, representing a complete lack of information. The segment is superposed to the occupancy grid, pose xᵣ determining the position of its origin and its orientation. Each cell cᵢ of the occupancy grid intersected by the segment will receive a corresponding occupancy probability value; other cells take an occupancy probability equal to 0.5.

### Using a Range Measurement for Updating the Pose Grid

Updating the pose grid upon reception of a range measurement means computing P(xᵣ|z). For xᵣ∈Π:

$$P ( {x}_{r} \vert z ) = \frac{p ( {x}_{r} , z )}{p ( z )} \qquad ( 3 )$$

The denominator p(z) is a constant factor, therefore (3) can be written

P(xᵣ|z)=η·p(xᵣ, z) (4)

η being a constant.

For the sake of simplicity, it will be considered that the position grid L coincides with the occupancy grid G. Therefore, let xᵣ=(cₙ, αₘ). For given n and m, one may define G^{xr} be the projection of the occupancy grid G onto the range sensor field of view when the sensor itself is located at Xᵣ=cₙ and having a heading αᵣ=αₘ. Then, summing over all the possible configurations Gₖ^{xr} of G^{xr}:

$$p ( {x}_{r} , z ) = {\sum }_{k} p ( {x}_{r} , z , {G}_{k}^{xr} ) = {\sum }_{k} p ( z \vert {x}_{r} , {G}_{k}^{xr} ) \cdot P ( {G}_{k}^{xr} ) \cdot P ( {x}_{r} ) \qquad ( 5 )$$

and therefore (4) can be written

P(xᵣ|z)=η·P(xᵣ)·Σₖp(z|xᵣ, Gₖ^{xr})·P(Gₖ^{xr}) (6)

All the terms of (6) are either known or easily computed:
η is simply a normalization factor;
P(xᵣ) is the previously-computed pose probability;
p(z|xᵣ, Gₖ^{xr}) is the range sensor model evaluated when the carrier takes a pose xᵣ and for a given configuration of the occupancy grid, which may be tabulated and stored in a memory device.

P(Gₖ^{xr}) is the probability of a given configuration of the occupancy grid, which in turn depends on the occupancy probabilities P(oᵢ). Assuming that the projected grid G^{xr} has Nₓᵣ elements, the a priori probability of any configuration is

$$P ( {G}_{k}^{xr} ) = \frac{1}{{2}^{{N}_{xr}}} .$$

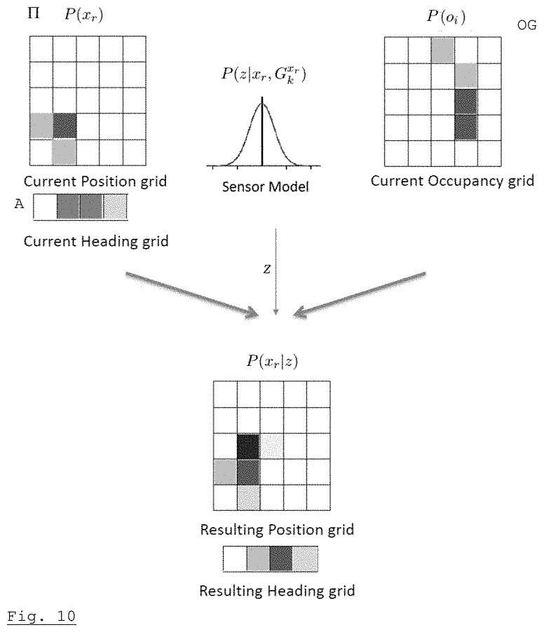

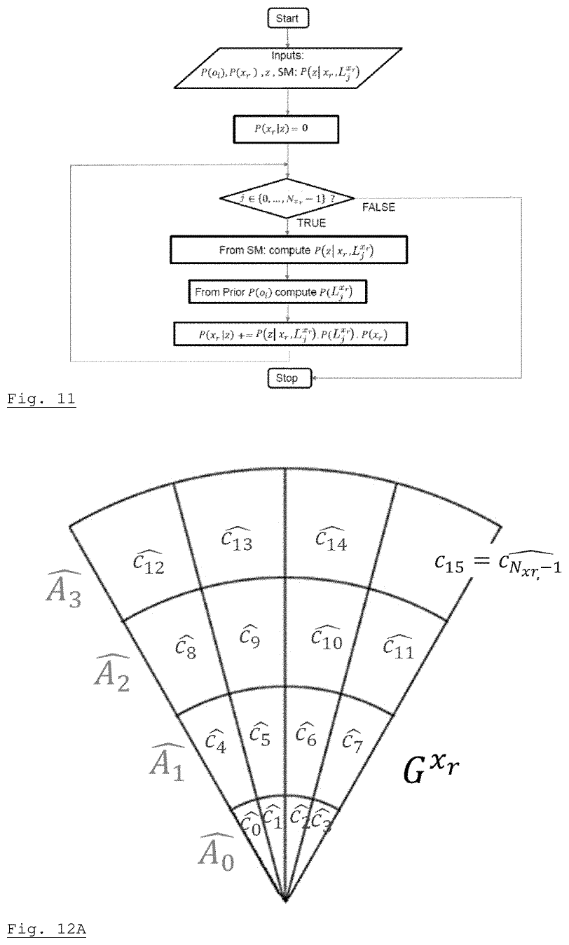

The computation of P(xᵣ|z) is illustrated on FIG. 10.

The number of terms involved in the sum of (6) depends on the kind of range sensor considered. For instance, while in the most general case this number of terms is an exponential function of the number of cells Nₓᵣ, in the case of a LIDAR sensor it is equal to Nₓᵣ (i.e. the complexity is linear); the same is true for wide-field sensor if the nearest-target approximation applies (see below, equations 9 and 10, and above-cited European Patent Application 18305955). Indeed, a LIDAR only detects the nearest target, therefore two different configurations having a same nearest occupied cell give identical contributions. Let Lⱼ^{xr} be the event “the first occupied cell in Gₖ^{xr} is ĉⱼ”. This means that all cells ĉᵢ, i<j, are empty and that cells ĉᵢ, i>j can have any state. Summing all possible events Lⱼ^{xr}, j={0, . . . Nₓᵣ−1}, (6) can be written as:

$$P ( {x}_{r} \vert z ) = η \cdot P ( {x}_{r} ) \cdot {\sum }_{j} P ( z \vert {x}_{r} , {L}_{j}^{xr} ) \cdot P ( {L}_{j}^{xr} ) \qquad ( 7 )$$

wherein:
P(z|xᵣ, Lⱼ^{xr}) is the sensor model evaluated when the carrier takes a pose xᵣ and an obstacle is located at the distance ĉⱼ from xᵣ. Usually this model is given by a normal distribution [symbol] (dⱼ(xᵣ), σ) where dⱼ(xᵣ) is the distance of ĉⱼ to xᵣ and σ a standard deviation;
P(Lⱼ^{xr}) is the probability of event Lⱼ^{xr}, which is given by:

$$P ( {L}_{j}^{xr} ) = P ( o ( {c}_{j} ) ) \cdot {\prod }_{i = 0}^{j - 1} P ( e ( {c}_{j} ) ) \qquad ( 8 )$$

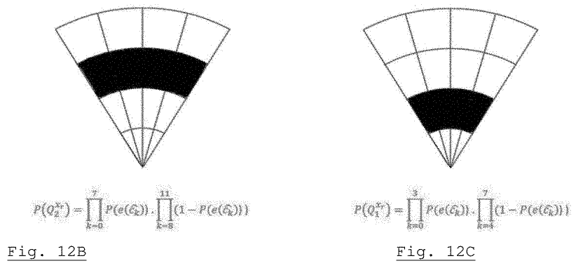

For sensors having a large field of view, the occupancy grid may take the form illustrated on FIG. 12A, wherein several cells are situated at a same distance from the sensor and form an “arc”. In particular, in the example of FIG. 12A, cells ĉ₀ to ĉ₃ form a first arc Â₀, cells ĉ₄ to ĉ₇ form a second arc Â₁, cells ĉ₈ to ĉ₁₁ form a third arc Â₂ and cells ĉ₁₂ to ĉ₁₅= [symbol] form a fourth arc Â₃=Â_{Mxr-1} If a cell of the arc is occupied, the arc is considered to be occupied.

If the nearest-target hypothesis can be applied, for two configurations Gₖ₁^{xr} and Gₖ₂^{xr} sharing the same nearest occupied arc, p(z|xᵣ, Gₖ₁^{xr}) can be taken to be equal to p(z|xᵣ, Gₖ₂^{xr}). Thus for G^{xr}={ĉ₀, ĉ₁, . . . , [symbol] }={ [symbol] , . . . , [symbol] }Qⱼ^{xr} is defined, for j=0, . . . , Nₓᵣ−1, as the event “Âⱼ is the first occupied arc in G^{xr}” (as a consequence, all cells in arcs Âᵢi<j are empty and cells in a Âᵢi>j can be in any state. Summing all possible events Qⱼ^{xr}, equation (6) may be written:

$$P ( {x}_{r} \vert z ) = η \cdot P ( {x}_{r} ) \cdot {\sum }_{j} P ( z \vert {x}_{r} , {Q}_{j}^{xr} ) \cdot P ( {Q}_{j}^{xr} ) \qquad ( 9 )$$

where P(Qⱼ^{xr}) is the probability of having the arc Âⱼ as the first occupied arc, i.e. the probability of having all arcs Âᵢi<j empty, which is given by:

$$P ( {Q}_{j}^{xr} ) = {Π}_{{\hat{c}}_{k} ∈ {\hat{A}}_{j}} ( 1 - P ( e ( {\hat{c}}_{k} ) ) ) \cdot {\prod }_{i = 0}^{j - 1} {Π}_{{\hat{c}}_{k} ∈ {\hat{A}}_{k}} P ( e ( {\hat{c}}_{i} ) ) \qquad ( 10 )$$

FIGS. 12B and 12C illustrate the events Q₂^{xr} and Q₁^{xr}, respectively.

### Using an Odometry Measurement for Updating the Pose Grid

Different kind of motion sensors can be used in order to update the carrier pose, such as IMU (Inertial Measurement Units), GPS, wheel encoders . . . The pose distribution at time t=0, P₀(xᵣ) is deemed to be known, and updated when an odometry measurement u is received. The problem is then to compute Pₜ(xᵣ|u) from Pₜ₋₁(xᵣ).

For a fixed pose xᵣ*, Pₜ(xᵣ*|u) is computed by summing over all possible poses:

$${P}_{t} ( {x}_{r}^{*} \vert u ) = {\sum }_{{x}_{r}} P ( {x}_{r}^{*} \vert {x}_{r} , u ) \cdot P ( {x}_{r} \vert u ) \qquad ( 11 )$$

Taking into account the fact that P(xᵣ|u)=Pₜ₋₁(xᵣ), (11) becomes:

$${P}_{t} ( {x}_{r}^{*} \vert u ) = {\sum }_{{x}_{r}} P ( {x}_{r}^{*} \vert {x}_{r} , u ) \cdot {P}_{t - 1} ( {x}_{r} ) \qquad ( 12 )$$

wherein:
P(xᵣ*|xᵣ, u) is the motion model that depends on the type of the chosen motion sensor, and is usually tabulated and stored in a memory device;
Pₜ₋₁(xᵣ) is the previously computed (or initial, if t−1=0) pose distribution.

### Integer Computations

A potential problem with the inventive method described above is that, in a nave implementation, computations would need to be performed using floating point arithmetic. The use of floating-point computation requires significant resources in terms of computing power, which are hardly compatible with the constraints specific to embedded systems.

According to some advantageous embodiments of the invention, however, occupancy and pose probability may be updated by making use of much simpler integer computation, while keeping an acceptable accuracy level.

It is worth noting that WO2017/050890 (already cited) discloses a method for updating occupancy grids only using integer computations. This method alone, however, is not sufficient to allow updating pose grids, too, without floating point computations.

Evaluating equations (1)-(12) requires five kind of elementary operations:
additions;
additive inversions—i.e. computing the complement to one of an operand;
multiplications;
divisions;
“probability fusion”, corresponding to equation (2).

Two alternative embodiments will be described, allowing carrying out all these operations using integer computation only. According to both embodiments of the invention, the probability values are discretized, i.e. they can only take values belonging to a finite set. The first embodiment uses a first, non-uniform discretization scheme and the second embodiment uses a second, uniform discretization scheme. A third discretization scheme (already disclosed in WO2017/050890) is used for carrying out “integer fusion”—it is therefore necessary to map the first or second discretization scheme onto the third and vice-verse, which can be done very cheaply using a lookup table.

### First Embodiment

Let ϵ be a real value in ]0,1[. The discretization set D_{log} of size N_{log} is defined as:

D_{log}={1, (1−ϵ), (1−ϵ)², . . . , 0.5, . . . , (1−ϵ)^{N}^{_{log}}⁻², 0} (13)

It should be noted that ϵ is chosen such that it exists an integer n (usually n=N_{log}/2 or n=N_{log}/4) satisfying (1−ϵ)ⁿ=0.5.

It can be easily verified that, for i,j∈{0 . . . , N_{log}−1}, the product of D_{log}[i] by D_{log}[j] given by:

$$\vert {D}_{log} [ i ] ⊗ {D}_{log} [ j ] = \{ \begin{matrix}{D}_{log} [ i + j ] & if i + j \leq {N}_{log} - 1 \\ 0 & otherwise \end{matrix} \qquad ( 14 )$$

Therefore, the product of two values (probabilities, probability densities) discretized according to the discretization set D_{log} can be computed using an integer operation on integer indexes.

The division of D_{log}[i] by D_{log}[j] is given by:

$${D}_{log} [ i ] ⊗ {D}_{log} [ j ] = \{ \begin{matrix}undefined & if j = {N}_{log} - 1 \\ 0 & if i = {N}_{log} - 1 \\ {D}_{log} [ i - j ] & if i \geq j \\ 1 & if i < j \end{matrix} \qquad ( 15 )$$

Interestingly, in the inventive method, division is only used to compute the normalization factor η<1, therefore the first condition never occurs. Again, only an integer operation on indexes needs to be performed.

The addition of D_{log}[i] and D_{log}[j], however, gives a result which—in general—does not belong to D_{log}. Indeed, one should solve the following equation

(1−ϵ)^{k}^{₊}^{^{i,j}}=(1−ϵ)ⁱ+(1−ϵ)^{j} (16)

which gives:

$${k}_{+}^{i , j} = \frac{log ( {( 1 - ϵ )}^{i} + {( 1 - ϵ )}^{j} )}{log ( 1 - ϵ )} \qquad ( 17 )$$

Clearly, k₊^{i,j} is not necessarily an integer. However, one may take the floor (or, alternatively, the ceiling, or the closest integer etc.) of (17), so that k₊^{i,j} is redefined as:

$${k}_{+}^{i , j} = floor ( \frac{log ( {( 1 - ϵ )}^{i} + {( 1 - ϵ )}^{j} )}{log ( 1 - ϵ )} ) \qquad ( 18 )$$

Addition is then represented by:

$${D}_{log} [ i ] ⊕ {D}_{log} [ j ] = \{ \begin{matrix}{D}_{log} [ i ] & if j = {N}_{log} - 1 \\ {D}_{log} [ j ] & if i = {N}_{log} - 1 \\ {D}_{log} [ {k}_{+}^{i , j} ] & for {k}_{+}^{i , j} in ( 18 ) and if 0 \leq {k}_{+}^{i , j} \leq {N}_{log} - 1 \\ 1 & if {k}_{+}^{i , j} < 0 \\ 0 & if {k}_{+}^{i , j} > {N}_{log} - 1 \end{matrix} \qquad ( 19 )$$

Computing the addition using (18) and (19) requires floating point operations. However, it is possible to compute (19) offline for all pairs (i,j) and store them in a lookup table. Note that, since addition is symmetric, the table only needs to store N_{log}²/2 terms.

Additive inversion is performed in a similar way:
k₋^{i,j} is defined as follows:

$${k}_{-}^{i} = floor ( \frac{log ( 1 - {( 1 - ϵ )}^{i} )}{log ( 1 - ϵ )} ) \qquad ( 20 )$$

1⊖D_{log}[j] is then defined as:

$$1 ⊖ {D}_{log} [ i ] = \{ \begin{matrix}1 & if i = {N}_{log} - 1 \\ 0 & if i = 0 \\ {D}_{log} [ {k}_{-}^{i} ] & for {k}_{-}^{i} in ( 20 ) and if 0 \leq {k}_{-}^{i} \leq {N}_{log} - 1 \\ 1 & if {k}^{i} < 0 \\ 0 & if {k}_{-}^{i} > N {\vert}_{log} - 1 \end{matrix} \qquad ( 21 )$$

Like for addition, (21) is computed offline and stored in a table of size N_{log}.

As mentioned above, fusion requires mapping D_{log} to a different discretization set Gₚ, the result being then mapped back to D_{log}. The theory of integer probability fusion was disclosed in WO2017/050890 and will be briefly recalled here.

Let p be a probability value that verifies

0.5<p<1 (22)

A sequence pₙ(n∈ [symbol] ) is defined as follows:

$${p}_{0} = 1 \text{/} 2 \\ {p}_{1} = p \\ {p}_{2} = F ( p , p ) \\ {p}_{3} = F ( {p}_{2} , p ) \\ … \\ {p}_{n + 1} = F ( {p}_{n} , p ) \qquad ( 23 )$$

where F(.,.) is the fusion operator

$$F ( p , q ) = \frac{p . q}{p . q + ( 1 - p ) . ( 1 - q )} \qquad ( 24 )$$

The definition of pₙ is then extended to negative integer values of n as follows:

$${p}_{0} = 1 \text{/} 2 \\ {p}_{- 1} = 1 - p \\ {p}_{- 2} = F ( 1 - p , 1 - p ) \\ {p}_{- 3} = F ( {p}_{- 2} , 1 - p ) \\ … \\ {p}_{- n - 1} = F ( {p}_{- n} , 1 - p ) \qquad ( 25 )$$

The discretization schemes, depending on parameter p∈]0.5;1[ are then defined as follows:

Gₚ⁻={(pₙ), n≤0} (26)

Gₚ⁺={(pₙ), n≥0} (27)

It can be shown that the fusion of two elements pᵢ and pⱼ belonging to Gₚ=Gₚ⁺∪Gₚ⁻ is defined by:

F(pᵢ, pⱼ)=pᵢ₊ⱼ (28)

Therefore, Gₚ is a discretization scheme which does not introduce errors when used for performing probability fusion.

As explained above, according to the present embodiment of the invention, when fusion has to be performed in order to update the occupancy grid upon reception of a range measurement, D_{log} is mapped onto Gₚ, fusion is performed, and the result is mapped back onto D_{log}, the mapping being performed using lookup tables stored in a memory device.

More precisely, let f_{G}_{ₚ}(i),∀i∈{0, . . . , N_{log}−1} be the index of the closest element in Gₚ to D_{log}[i].

The values of this function are then stored offline in a lookup table. Similarly, for pi∈Gₚ, let f_{D}_{_{log}}(i) be the index of the closest element to pᵢ in D_{log}. Then, for i,j∈{0, . . . , N_{log}−1} the fusion of D_{log}[i] and D_{log}[j] is defined by:

$$F ( {D}_{log} [ i ] , {D}_{log} [ j ] ) = {f}_{{D}_{log}} ( {p}_{{f}_{{G}_{p}} ( i ) + {f}_{{G}_{p}} ( j )} ) \qquad ( 29 )$$

### Second Embodiment

Let N*∈ [symbol] *. The discretization set D_{unif} of size N*+1 is defined as:

$${D}_{unif} = \{ 0 , \frac{1}{{N}^{*}} , … , 0.5 , … , \frac{{N}^{*} - 2}{{N}^{*}} , \frac{{N}^{*} - 1}{{N}^{*}} , 1 \} \qquad ( 30 )$$

The set D_{unif} represents a discretization of the probabilities in [0, 1].

For i,j∈{0, . . . N*} the addition of D_{unif}[i] and D_{unif}[j] is simply given by:

$${D}_{unif} [ i ] ⊕ {D}_{unif} [ j ] = \{ \begin{matrix}{D}_{unif} [ i + j ] & if i + j \leq {N}^{*} \\ 1 & otherwise \end{matrix} \qquad ( 31 )$$

Therefore, the sum of two values (probabilities, probability densities) discretized according to the discretization set D_{unif} can be computed using an integer operation on integer indexes. The same applies to additive inversion. Indeed, for i∈{0, . . . N*}, 1−D_{unif}[i] is given by:

$$1 ⊖ {D}_{unif} [ i ] = \{ \begin{matrix}{D}_{unif} [ {N}^{*} - i ] & if {N}^{*} - i \geq 0 \\ 0 & otherwise \end{matrix} \qquad ( 32 )$$

For j∈{0, . . . N*} the product of D_{unif}[i] and D_{unif}[j] cannot be exactly represented in D_{unif}. Indeed, one should solve the following equation for k_{×}^{i,j}:

$$\frac{{k}_{\times }^{i , j}}{{N}^{*}} = \frac{i}{{N}^{*}} \cdot \frac{j}{{N}^{*}} \qquad ( 33 )$$

which yields

$${k}_{\times }^{i , j} = \frac{i \cdot j}{{N}^{*}} \qquad ( 34 )$$

It can be easily understood that k_{×}^{i,j} is not necessarily an integer. As in the first embodiment, one can take the floor of (34)—or, alternatively, the ceiling, or the closest integer etc.—and redefine k_{×}^{i,j} as:

$${k}_{\times }^{i , j} = floor ( \frac{i \cdot j}{{N}^{*}} ) \qquad ( 35 )$$

Thus, multiplication in D_{unif} is represented by

$${D}_{unif} [ i ] ⊗ {D}_{unif} [ j ] = \{ \begin{matrix}{D}_{unif} [ i ] & if j = {N}^{*} \\ {D}_{unif} [ j ] & if i = {N}^{*} \\ 0 & if i = 0 or j = 0 \\ {D}_{unif} [ {k}_{\times }^{i , j} ] & for {k}_{\times }^{i , j} in ( 35 ) and if 0 \leq {k}_{\times }^{i , j} \leq {N}^{*} \\ 0 & if {k}_{\times }^{i , j} < 0 \\ 1 & if {k}_{\times }^{i , j} > {N}^{*} \end{matrix} \qquad ( 36 )$$

The values of D_{unif}[i]⊗D_{unif}[j], as defined in (36), for all i,j pairs are then computed offline and stored in a lookup table.

Division is dealt with similarly. One should solve the following equation for k_{d}^{i,j}:

$$\frac{{k}_{d}^{i , j}}{{N}^{*}} = \frac{i}{{N}^{*}} \div \frac{j}{{N}^{*}} \qquad ( 37 )$$

which yields:

$${k}_{d}^{i , j} = \frac{i \cdot {N}^{*}}{j} \qquad ( 38 )$$

As (38) does not necessarily gives an integer value, k_{d}^{i,j} is redefined by taking the floor of (38):

$${k}_{d}^{i , j} = floor ( \frac{i \cdot {N}^{*}}{j} ) \qquad ( 39 )$$

Division in D_{unif} is then represented by:

$${D}_{unif} [ i ] ⊗ {D}_{unif} [ j ] = \{ \begin{matrix}undefined & if j = 0 \\ {D}_{unif} [ i ] & if j = {N}^{*} \\ 0 & if i = 0 \\ 1 & if i = j \\ {D}_{unif} [ {k}_{d}^{i , j} ] & for {k}_{d}^{i , j} in ( 39 ) and if 0 \leq {k}_{d}^{i , j} \leq {N}^{*} \\ 0 & if {k}_{d}^{i , j} < 0 \\ 1 & if {k}_{d}^{i , j} > {N}^{*} \end{matrix} \qquad ( 40 )$$

Note that, in the inventive method, the first condition (j=0, leading to an undefined result) can never occur. As for product, the values of D_{unif}[i]∅D_{unif}[j], as defined in (40), for all i,j pairs (except j=0) are then computed offline and stored in a lookup table.

Fusion is dealt with in a similar way than in the first embodiment. g_{G}_{ₚ}(i),∀i∈{0, . . . , N*} is defined as the index of the closest element of Gₚ to D_{unif}[i]. The values of this function are stored in a lookup table. Similarly, for pᵢ∈Gₚ, let g_{D}_{_{unif}}(i) be the index of the closest element to pᵢ in D_{unif}. Then, for i,j∈{0, . . . , N*} the fusion of D_{unif}[i] and D_{unif}[j] is defined by:

$$F ( {D}_{unif} [ i ] , {D}_{unif} [ j ] ) = {g}_{{D}_{unif}} ( {p}_{{g}_{{G}_{p}} ( i ) + {g}_{{G}_{p}} ( j )} ) \qquad ( 41 )$$

Both the first and the second embodiments allow then to carry out the inventive method using only:
integer computations on said integer indices; and
using integer indices for retrieving pre-computed results in lookup tables.

The invention has been described with reference to embodiments wherein a single mobile body, carrying odometry and distance sensors, is localized, and its environment is mapped. Other embodiments are possible. For instance, some or even all of the sensors may not be embarked on the mobile body—e.g. an external Doppler radar may be used to obtain relevant odometry measurements. Moreover, several sensor-carrying mobile bodies moving within a same environment may share—and contribute to update—a single occupancy grid, while having each a respective pose grid.

### REFERENCES

[1] A. Elfes, “Occupancy grids: a stochastic spatial representation for active robot perception”, Sixth Conference on Uncertainty in AI, 1990.

[2] D. Fox, W. Burgard, and S. Thrun, “Markov localization for mobile robots in dynamic environments”, Journal of Artificial Intelligence Research, 1999.

[3] M. Montemerlo, S. Thrun, D. Koller, and B. Wegbreit “FastSLAM: A factored solution to the simultaneous localization and mapping problem” in AAAI National Conference on Artificial Intelligence. AAAI, pp. 593-598, 2002.

[4] T. Duckett and U. Nehmzow “Mobile robot self-localisation using occupancy histograms and a mixture of gaussian location hypotheses” Robotics and Autonomous Systems, vol. 34, no. 2, pp. 117-129, 2001.

[5] J. Nordh and K. Berntorp “Extending the occupancy grid concept for low-cost sensor-based slam” in IFAC Proceedings Volumes, vol. 45, no. 22, Elsevier, pp. 151-156, 2012.

[6] K. P. Murphy, “Bayesian map learning in dynamic environments” in Advances in Neural Information Processing Systems, pp. 1015-1021, 2000.

1. A method of performing simultaneous localization of a mobile body and mapping of its environment, the method comprising the following steps, carried out by a data processor:
a) defining:
an occupancy grid on a region of said environment, the grid comprising a plurality of cells, an occupancy probability by an obstacle being associated to each cell of the occupancy grid, and
a pose grid comprising a plurality of cells, each representing a position and orientation of the mobile body, a pose probability being associated to each cell of the pose grid;
b) receiving a first time series of distance measurements, each of said measurements being representative of a distance between a point of the mobile body and at least one nearest obstacle and, upon reception of a distance measurement: either
b1) updating the occupancy probabilities of the occupancy grid as a function of present values of said occupancy probabilities, of the received distance measurement and of the pose probabilities of the pose grid; or
b2) updating the pose probabilities of the pose grid as a function of present values of said pose probabilities, of the received distance measurement and of the occupancy probabilities of the occupancy grid; and
c) receiving a second time series of odometry measurements (u₁, u₂), each of said measurements being representative of a motion of the mobile body in the environment and, upon reception of an odometry measurement, updating the pose probabilities of the pose grid as a function of present values of said pose probabilities and of the received odometry measurement;
part of the distance measurements being used for updating the pose probabilities of the pose grid and part of the distance measurements being used for updating the pose probabilities of the occupancy grid.

2. The method of claim 1, wherein steps b) and c) are carried out asynchronously.

3. The method of claim 1, wherein said updating the occupancy probabilities of the occupancy grid comprises:
building a temporary occupancy grid comprising a plurality of cells, each associated to an occupancy probability computed as a weighted sum of a plurality of contributions obtained by applying to the distance measurement a plurality of inverse statistical models of a corresponding distance sensor, each inverse model being associated to a cell of the pose grid and weighted by the corresponding pose probability; and
fusing the occupancy probabilities of the occupancy grid and of the temporary occupancy grid.

4. The method of claim 1, wherein said updating the pose probabilities of the pose grid upon reception of a distance measurement comprises multiplying the present values of said pose probabilities by a weighted sum of direct statistical models of a corresponding distance sensor for all possible configurations of the occupancy grid, a configuration attributing an ‘empty’ or an ‘occupied’ state to each cell of the occupancy grid, each weight being proportional to a probability of the corresponding configuration.

5. The method of claim 1, wherein said updating the pose probabilities of the pose grid upon reception of an odometry measurement comprises computing a weighted sum of a plurality of contribution obtained by applying to the odometry measurement a plurality of inverse statistical models of a corresponding motion sensor (OS), each inverse model being associated to a cell of the pose grid and weighted by the corresponding probability.

6. The method of claim 1, wherein probability values are constrained to take discrete values belonging to a first set of finite cardinality, each element of the first set being identified by an integer index, and wherein updating the occupancy probabilities of the occupancy grid, updating the probabilities of the pose grid upon reception of a distance measurement and updating the probabilities of the pose grid upon reception of an odometry measurement are carried out exclusively by:
performing integer computations on said integer indices; and
using said integer indices for retrieving pre-computed results stored in a memory.

7. The method of claim 6, wherein said first set of finite cardinality corresponds to a discretization of a [0, 1] interval according to an exponential law, whereby multiplications and divisions are carried out by performing integer computations on integer indices of the first set, while additions and additive inversions are carried out using integer indices of the first set for retrieving pre-computed results stored in a memory.

8. The method of claim 6, wherein said first set of finite cardinality corresponds to a linear discretization of a [0, 1] interval, whereby additions and additive inversions are carried out by performing integer computations on integer indices of the first set, while multiplications and divisions are carried out using integer indices of the first set for retrieving pre-computed results stored in a memory.

9. The method of claim 3, wherein probability values are constrained to take discrete values belonging to a first set of finite cardinality, each element of the first set being identified by an integer index, and wherein updating the occupancy probabilities of the occupancy grid, updating the probabilities of the pose grid upon reception of a distance measurement and updating the probabilities of the pose grid upon reception of an odometry measurement are carried out exclusively by:
performing integer computations on said integer indices; and
using said integer indices for retrieving pre-computed results stored in a memory;
the method comprising:
projecting the discrete values belonging to the first set onto discrete values belonging to a second set of finite cardinality, each element of the second set being identified by an integer index;
fusing the occupancy probabilities of the occupancy grid and of the temporary occupancy grid by performing integer computations on the integer indices of the second set; and
projecting back the discrete values belonging to the second set onto discrete values belonging to the first set.

10. The method of claim 9, wherein said second set of finite cardinality is formed by the union of two subsets Gₚ⁻ et Gₚ⁺ defined by:
Gₚ⁻={(pₙ), n≤0}
Gₚ⁺={(pₙ), n≥0}
wherein n is a relative integer index, p a parameter taking a value strictly comprised between 0.5 and 1 and values pₙ are recursively defined by
p₀=0,5;
p₁=p;
pₙ₊₁=F(pₙ, p)∀n>1
p₋₁=1−p;
pₙ₋₁=F(pₙ, p₋₁)∀n<−1
whereby fusing occupancy probabilities pᵢ and pⱼ is carried out by computing:
F(pᵢ, pⱼ)=pᵢ₊ⱼ

11. An apparatus for performing simultaneous localization of a mobile body and mapping of its environment, comprising:
at least one input port for receiving a plurality of signals representative of a first time series of distance measurements arising from one or more distance sensor and a second time series of odometry measurements arising from one or more motion sensor; and
a data processor configured to
a) define:
an occupancy grid on a region of said environment, the grid comprising a plurality of cells, an occupancy probability by an obstacle being associated to each cell of the occupancy grid, and
a pose grid comprising a plurality of cells, each representing a position and orientation of the mobile body, a pose probability being associated to each cell of the pose grid;
b) receive the first time series of distance measurements, each of said measurements being representative of a distance between a point of the mobile body and at least one nearest obstacle and, upon reception of a distance measurement: either
b1) update the occupancy probabilities of the occupancy grid as a function of present values of said occupancy probabilities, of the received distance measurement and of the pose probabilities of the pose grid; or
b2) update the pose probabilities of the pose grid as a function of present values of said pose probabilities, of the received distance measurement and of the occupancy probabilities of the occupancy grid; and
c) receive the second time series of odometry measurements, each of said measurements being representative of a motion of the mobile body in the environment and, upon reception of an odometry measurement, updating the pose probabilities of the pose grid as a function of present values of said pose probabilities and of the received odometry measurement;
part of the distance measurements being used for updating the pose probabilities of the pose grid and part of the distance measurements being used for updating the pose probabilities of the occupancy grid.

12. The apparatus of claim 11, also comprising one or more distance sensors adapted to generate signals representative of said distance measurements and one or more motion sensors adapted to generate signals representative of said odometry measurements, said sensor being linked to said input port or ports.

13. A mobile robot carrying an apparatus according to claim 12.
